(19) United States
(12) Patent Application Publication
(10) Pub. No.: US 2009/0108810 A1
(43) Pub. Date: Apr. 30, 2009

(54) BATTERY CHARGING BASED ON BATTERY CAPACITY

(76) Inventor: Thomas P. SAWYERS, Hempstead, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/932,087

(22) Filed: Oct. 31, 2007

(51) Int. Cl. H02J 7/00; H01M 10/44

(52) U.S. Cl. 320/137

(57) ABSTRACT

A method comprises dynamically updating a register in a battery pack to include a value that is indicative of a present capacity of the battery pack. The method also comprises reading the value from the register and setting a charge current level to charge the battery pack based on the value read from the register.

### BACKGROUND

Some types of battery-operated devices use rechargeable batteries and thus include a battery charger. Portable computers are an example of such devices. In a portable computer, the battery charging circuit is configured to provide a predetermined current level to a rechargeable battery pack. In general, the capacity of a battery (i.e., the amount of energy that can be stored in the battery) decreases as the battery undergoes numerous charge/discharge cycles. Eventually, the capacity of the battery may be insufficient for a given application.

### BRIEF DESCRIPTION OF THE DRAWINGS

For a detailed description of exemplary embodiments of the invention, reference will now be made to the accompanying drawings in which:

FIG. 1 shows a system in accordance with various embodiments; and

FIG. 2 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a combination of two or more components. A system may be a wholly-operative system or a subsystem thereof.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

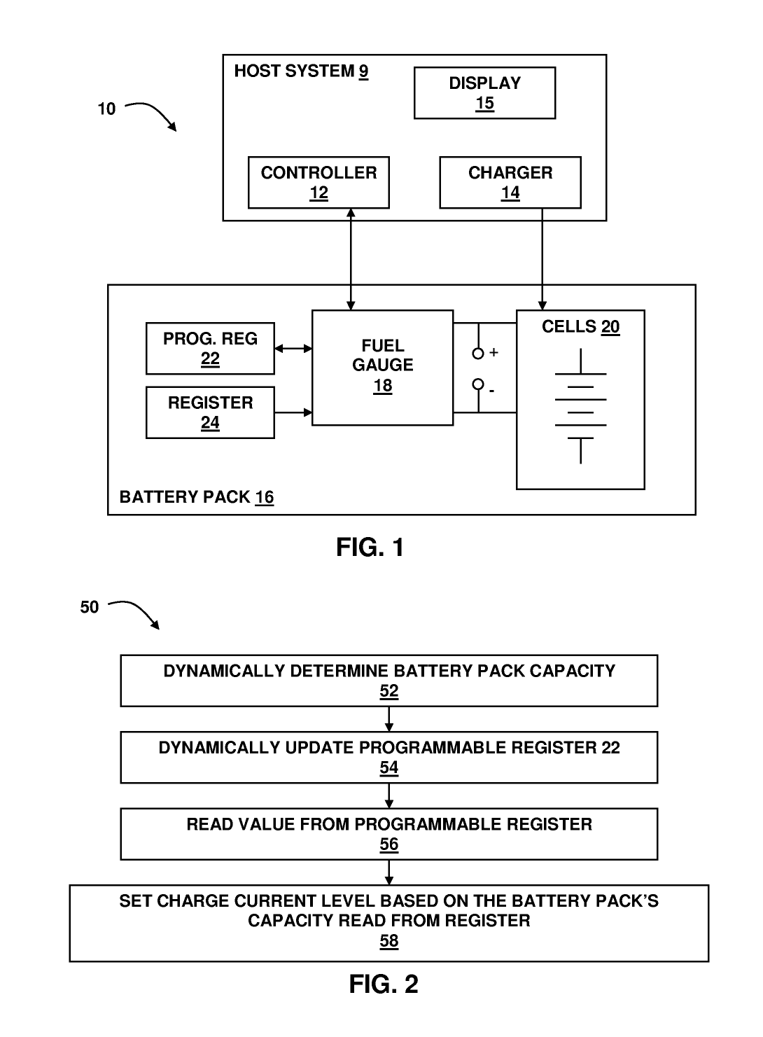

FIG. 1 shows a system 10 in accordance with various embodiments. As shown, system 10 comprises a host system 9 having, for example, a controller 12, a battery charger 14, and a display 15. The controller 12 may comprise an embedded controller (e.g., a keyboard controller) in some embodiments, the main processor of the system 10 in other embodiments, or a combination of an embedded controller and main processor in yet other embodiments. The charger 14 may be implemented as a charger circuit internal to a chassis containing the controller 12, etc., or as an external charging circuit (e.g., a “brick”). The host system 9 is powered by a rechargeable battery pack 16. The battery pack 16 comprises one more cells 20 coupled to a fuel gauge circuit 18. The battery pack 16 also comprises a programmable register 22 and another register 24. The registers 22 and 24 may be included as part of the fuel gauge 18 or in logic separate from the fuel gauge. In some embodiments, the register 22 is the FullChargeCapacity register in accordance with the Smart Battery Specification (SBS) 1.1 specification. Additional logic may be provided in the battery pack 20 as desired such as a protection circuit to detect fault conditions such as over-current, over-voltage, over-temperature, etc.

The fuel gauge 18 monitors the energy level of the cells 20 and provides such information to the controller 12. The controller 12 may cause, as desired by a user of the system 10, remaining battery charge information to be displayed on a display 15

The battery charger 14 provides current to the cells 20 of the battery pack 16 to charge the cells. The battery charger 14 is programmed by the controller 12 to generate a defined level of charge current for the battery pack 16. In various embodiments, the selected level of charge current is a function of the capacity of the battery pack. In this disclosure, the term “capacity” means the amount of energy stored in the battery pack 16 when the pack is fully charged. The battery pack's fuel gauge 18 dynamically determines the present capacity of the cells 20 and updates the programmable register 22 accordingly. For example, once per charge/discharge cycle, the fuel gauge determines the capacity of the cells 20 and programs a value indicative of such dynamically-determined capacity into the programmable register 22. Thus, the programmable register is periodically updated to include a value indicative of the present capacity of the battery pack 16. As the capacity of the battery pack 16 changes over time (e.g., decreases with increasing number of charge/discharge cycles), the battery pack capacity value in the programmable register 22 will change as well. In some embodiments, the fuel gauge 18 determines a new capacity value of the battery pack 16 during each charge/discharge cycle, while in other embodiments, the fuel gauge determines the battery pack's capacity at other intervals (e.g., every other charge/discharge cycle, once per day, etc.).

Any of a variety of techniques can be implemented by the fuel gauge 18 to determine the capacity of the battery pack. For example, the fuel gauge 18 may employ “coulomb accounting” whereby the fuel gauge records the initial charge level of the battery pack upon being fully charged and keeps track of the amount of charge consumed from the battery pack during run-time of the system 10, and/or keeps track of the amount of charge entering the battery pack during recharge.

The fuel gauge 18 informs the controller 12 when the battery pack 16 is to be charged. The controller 12 reads the contents of the programmable register 22 to determine (e.g., be informed of) the battery pack's present capacity. In various embodiments, the controller 12 multiplies the value read from the programmable register by a factor. In some embodiments, the factor is 0.7, but can be other than 0.7 in other embodiments. The controller 12 then programs the charger 14 to generate a charge current level that, in some embodiments, is equal to the capacity multiplied by the factor. As the battery pack capacity decreases, or increases, over its life, the charge current level will be adjusted as well commensurate with the change in the capacity. Charging the battery pack at a charge current level commensurate with (e.g., a function of) the battery pack's capacity will help to extend the useful life of the battery pack.

Referring still to FIG. 1, the register 24 in the battery pack 16 may be configured at the factory to include a value indicative of the initial capacity of the battery pack. In various embodiments, the value written to register 24 is not changed during operation of the system 10. Some systems may use the contents of the register 24 to program a battery charger, but because the contents of the register 24 do not change, neither does the charge current in such systems. In accordance with various embodiments, the use of the dynamically-programmed register 22 enables the charge current to be adjusted based on the potentially changing battery pack capacity. Register 24 may be a programmable register that is never updated, but only written at the factory.

FIG. 2 illustrates an embodiment of a method 50. At 52, method 50 comprises dynamically determining the capacity of the battery pack 16. At 54, method 50 comprises dynamically updating register 22 in the battery pack 16 with the dynamically determined battery pack capacity. At 56, the method further comprises the controller 12 reading the programmable register 22 to access the value that indicates the present capacity. At 58, the method comprises setting the charge current level in the charger 14 based on the pack's capacity.

In the embodiments described above, the battery pack's capacity is read from a register in the battery pack and used to compute charge current. In another embodiment, a battery pack register contains a count of the number of charge/discharge cycles the battery pack has undergone. The cycle count is indirectly indicative of the battery pack's capacity. The count is referred to as the “CycleCount.” The CycleCount can be used to compute charge current in any of a variety of ways. For instance, the charge current can be computed as the original charge current when the battery is new (programmed into the battery pack in a register at the factory) times (1-CycleCount/1000). Thus, after each cycle, the charge current is reduced by 1/1000^{th}. In another embodiment, the charge current is reduced by a fixed amount after each cycle by subtracting a value equal to the original charge current when the battery was new (explained above) and divided by 1000 from the previous charge current (PreviousCharge Current−(OriginalChargeCurrent/1000)).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
dynamically updating a register in a battery pack to include a value that is indicative of a present capacity of the battery pack;
reading the value from the register; and
setting a charge current level to charge the battery pack based on the value read from the register.

2. The method of claim 1 wherein dynamically updating the register in the battery pack comprises updating the register each charge/discharge cycle.

3. The method of claim 1 further comprising multiplying the value read from the register by a factor.

4. The method of claim 1 further comprising multiplying the value read from the register by a factor of 0.7.

5. The method of claim 1 wherein setting the charge current level comprises changing the charge current level at least once during the life of the battery pack.

6. The method of claim 1 wherein setting the charge current level comprises setting a different charge current multiple times during the life of the battery pack.

7. The method of claim 1 wherein dynamically updating the register to include a value comprises updating the register with a value indicative of the charge/discharge cycle count.

8. A system, comprising:
a battery pack containing a programmable register in which the battery pack dynamically updates a value indicative of the battery pack's capacity;
a controller coupled to said battery pack, said controller reads said programmable register from said battery pack; and
a battery charger coupled to said controller;
wherein said controller programs a charge current level of said battery charger based on said value read from said programmable register.

9. The system of claim 8 wherein said controller multiplies said value read from said programmable register by a factor.

10. The system of claim 8 wherein said controller multiplies said value read from said programmable register by 0.7.

11. The system of claim 8 wherein said battery pack updates the programmable register during each charge/discharge cycle of the battery pack.

12. The system of claim 8 wherein said controller changes the charge current level of said battery charger based on said value as read from said programmable register.

13. The system of claim 8 wherein said value is battery pack capacity.

14. The system of claim 8 wherein said value is a charge/discharge cycle count.

15. A system, comprising:
means for dynamically updating a register in a battery pack to include a value indicative of a present capacity of the battery pack;
means for reading the value from the register; and
means for setting a charge current level to charge the battery pack based on the value read from the register.

16. The system of claim 15 wherein the means for dynamically updating the register in the battery pack is for updating the register each charge/discharge cycle.

17. The system of claim 15 further comprising means for multiplying the value read from the register by a factor.

18. The system of claim 15 further comprising means for multiplying the value read from the register by a factor of 0.7.

19. The system of claim 15 wherein the means for setting the charge current level is for changing the charge current level at least once during the life of the battery pack.

20. The system of claim 15 wherein the means for setting the charge current level is for setting a different charge current multiple times during the life of the battery pack.
